(19) United States
(12) Patent Application Publication
(10) Pub. No.: US 2026/0284681 A1
(43) Pub. Date: Sep. 24, 2026

(54) SHOWER SYSTEM

(71) Applicant: BEIJING KOHLER LTD., Beijing (CN)

(72) Inventors: Sai YANG, Beijing (CN); Shuming MO, Beijing (CN); Shaopei WEI, Beijing (CN); Chia-Ying LEE, Beijing (CN); I-Shan HSIEH, Beijing (CN); Feiying SU, Beijing (CN)

(73) Assignee: BEIJING KOHLER LTD., Beijing (CN)

(21) Appl. No.: 19/476,670

(22) PCT Filed: Apr. 25, 2023
(86) PCT No.: PCT/CN2023/090693

§ 371 Date: Oct. 17, 2025

(51) Int. Cl. B05B 1/18; A47K 3/28

(52) U.S. Cl. CPC B05B 1/182; A47K 3/281; B05B 1/1892; B05B 1/192

(57) ABSTRACT

A shower system including interchangeable spray head elements includes: a handle including a connecting portion; and a plurality of spray heads. Each of the spray heads includes: an indicator configured to indicate a characteristic of water flow through therethrough; and a receiving portion configured to be removably coupled to the connecting portion. The handle includes a control configured to adjust a flow of water through each of the spray heads.

### CROSS-REFERENCE TO RELATED APPLICATIONS

This application is a National Phase of PCT Application No. PCT/CN2023/090693, filed Apr. 25, 2023, the entire contents of which are hereby incorporated by reference herein.

### BACKGROUND

The present disclosure relates generally to the field of shower systems, and spray heads for shower systems that deliver water to a user.

Various shower systems include a spray head having specific exterior characteristics, where the spray head may provide a particular spray profile. However, such a setup may be limiting to a user as a singular spray head, which may not be suitable for all use profiles.

### SUMMARY

The present disclosure relates generally to the field of shower systems and, more particularly, to shower systems having interchangeable spray heads. Embodiments of the present application provide a shower system having interchangeable features to provide a user with customizable spray options suitable for a range of use applications.

At least one aspect of the present disclosure relates to a shower system including: a handle including a connecting portion; and a plurality of interchangeable spray heads. Each of the interchangeable spray heads includes: an indicator configured to indicate a characteristic of water flow through therethrough; and a receiving portion configured to be removably coupled to the connecting portion. The handle includes a control configured to adjust a flow of water through each of the interchangeable spray heads.

Another aspect of the present disclosure relates to a shower system including: a handshower base configured to be fluidly coupled to a water supply, where the handshower base includes a first connecting portion; and a plurality of interchangeable spray head elements, where each of the interchangeable spray head elements includes a second connecting portion configured to removably couple the respective spray head to the handshower base at the first connecting portion via a twist-lock connection. At least one of the first connecting portion and the second connecting portion are configured to nest within the other of the first connecting portion and the second connecting portion when the respective spray head element is coupled to the handshower base. The interchangeable spray head elements each define at least a portion of a spray face when coupled to the handshower base.

Another aspect of the present disclosure relates to a handshower including a handle including a first connecting portion; and an interchangeable spray head element including a second connecting portion. The second connecting portion is configured to be removably coupled to the first connecting portion via a twist-lock connection to couple the interchangeable spray head element to the handle. The interchangeable spray head element defines at least a portion of a spray face of the handshower when the interchangeable spray head element is coupled to the handle.

Another aspect of the present disclosure relates to a method of using a shower system. The method includes: coupling a handle to a first spray head of a plurality of interchangeable spray heads by inserting a connection portion of the handle into a receiving portion of the first spray head, the first spray head corresponding to a first use application; adjusting, by a control disposed on the handle, a flow of water through the first spray head; decoupling the first spray head from the handle; mounting the first spray head onto a first dock; and coupling the handle to a second spray head of the plurality of interchangeable spray heads, the second spray head corresponding to a second use application.

Another aspect of the present disclosure relates to an interchangeable shower system. The shower system includes a handle having a connection portion and a plurality of spray heads, where each of the plurality of spray heads includes an indicator and a receiving portion. The connection portion of the handle is configured to be selectively coupled to the receiving portion of each of the plurality of spray heads. The handle includes at least one control, where the at least one control configured to adjust a flow of water through each of the spray heads. The indicator is configured to indicate at least one of a temperature or water flow through each of the plurality of spray heads.

Another aspect of the present disclosure relates to a method of using an interchangeable shower system. The method includes coupling a handle to a first spray head of a plurality of spray heads, where the first spray head corresponds to a first use application, and where coupling the handle to the first spray head includes inserting a connection portion of the handle into a receiving portion of the first spray head. The method also includes adjusting, by a control disposed on the handle, a flow of water through the first spray head. The method includes disconnecting the first spray head from the handle, mounting the first spray head onto a first dock, and coupling the handle to a second spray head of the plurality of spray heads, where the second spray head corresponds to a second use application.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a side view of a bathing environment including a shower system, according to an exemplary embodiment.

FIG. 2 is a front view of the shower system of FIG. 1, according to an exemplary embodiment.

FIG. 3 is a front perspective view of a docking portion of the shower system of FIG. 2, according to an exemplary embodiment.

FIG. 4 is a side perspective view of the docking portion of the shower system of FIG. 2, according to an exemplary embodiment.

FIG. 5 is a rear view of a first spray head within the shower system of FIG. 2, according to an exemplary embodiment.

FIG. 6 is a rear view of a second spray head within the shower system of FIG. 2, according to an exemplary embodiment.

FIG. 7 is another rear view of the first spray head within the shower system of FIG. 2, according to another exemplary embodiment.

FIG. 8 is another rear view of the second spray head within the shower system of FIG. 2, according to another exemplary embodiment.

FIG. 9 is a front perspective view of the first spray head within the shower system of FIG. 2, according to an exemplary embodiment.

FIG. 10 is a front perspective view of the second spray head within the shower system of FIG. 2, according to an exemplary embodiment.

FIG. 11 is a perspective view of a docking assembly within the docking portion of the shower system of FIG. 2, according to an exemplary embodiment.

FIG. 12A is a perspective view of the docking assembly within the docking portion of the shower system of FIG. 2, according to another exemplary embodiment.

FIG. 12B is a top perspective view of the docking assembly within the docking portion of the shower system of FIG. 2, according to another exemplary embodiment.

FIG. 12C is a side perspective view of the docking assembly of FIG. 12B.

FIG. 13A is a perspective view of the first spray head mounted to a docking assembly within the shower system of FIG. 2, according to an exemplary embodiment.

FIG. 13B is a perspective view of the first spray head mounted to a docking assembly within the shower system of FIG. 2, according to another exemplary embodiment.

FIG. 14 is a side cross-sectional view of the first spray head taken along line 13 -13 of FIG. 13A, according to an exemplary embodiment.

FIG. 15 is a front view of a handle within the shower system of FIG. 2, according to an exemplary embodiment.

FIG. 16 is a front view of the handle within the shower system of FIG. 2, according to another exemplary embodiment.

FIG. 17 is an exploded view of the first spray head and the handle of the shower system of FIG. 2, according to an exemplary embodiment.

FIG. 18 is a controller portion of the handle of FIG. 17, according to an exemplary embodiment.

FIG. 19 is a top view of the handle of FIG. 17, according to an exemplary embodiment.

FIG. 20 is a side cross-sectional view of the handle of FIG. 17, taken along line 19 -19 of FIG. 19, according to an exemplary embodiment.

FIG. 21 is a cross-sectional view of the controller portion of FIG. 18 in a first configuration, taken along line 19 -19 of FIG. 19, according to an exemplary embodiment.

FIG. 22 is a cross-sectional view of the controller portion of FIG. 18 in a second configuration, taken along line 19 -19 of FIG. 19, according to an exemplary embodiment.

FIG. 23 is a front view of spray heads and a handle for the shower system of FIG. 2, according to an exemplary embodiment.

FIG. 24 is a front perspective view of spray heads for the shower system of FIG. 2, according to another exemplary embodiment.

FIG. 25 is a rear perspective view of spray heads for the shower system of FIG. 2, according to an exemplary embodiment.

FIG. 26 is a schematic representation of various different types of spray heads for the shower system of FIG. 2, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Generally, shower systems may include one or more water outlets (e.g., primary shower head and/or a handheld shower), which may be configured to each provide a single or narrow range of spray profiles (i.e., output water having a flow with particular characteristics, such as continuous, pulsing, gentle, etc.). Some shower systems may include a shower head or handheld shower that may provide one or more spray modes. However, a user using the shower system is limited to the characteristics of the particular shower head or hand shower. In some instances, a particular shower head or handheld shower is not suitable for all use applications-despite having multiple spray profile settings. Accordingly, this disclosure relates to a shower system that includes multiple spray heads that may be interchangeably connected to a common handle such that a user may readily switch between spray heads to accommodate a multitude of use profiles.

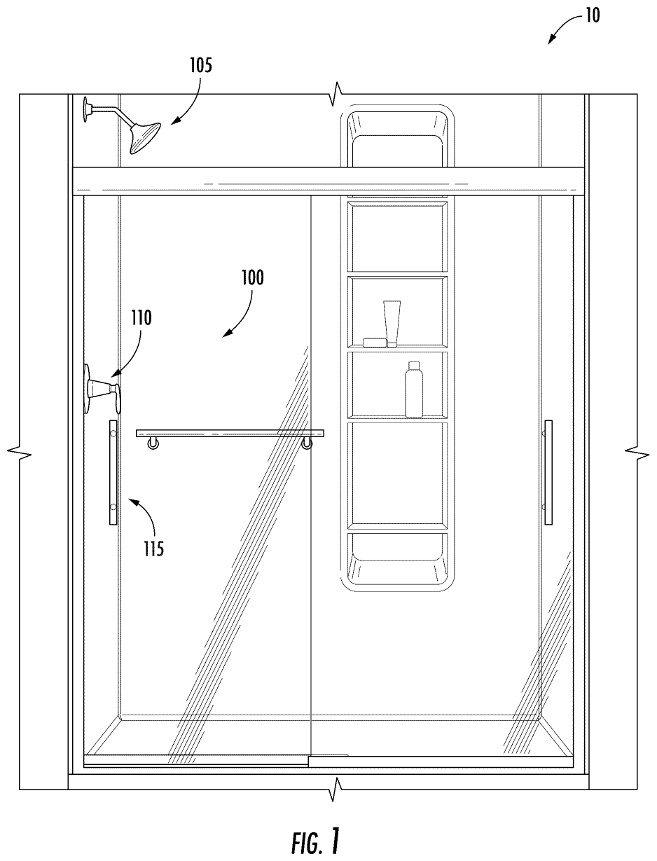

Referring to FIG. 1, a bathing environment 10 is shown, according to an exemplary embodiment. The bathing environment 10 may include a shower and/or bathtub or any other plumbing receptacle to facilitate a user to bathe therein. As shown, the bathing environment 10 includes a shower system 100. The shower system 100 includes at least one outlet 105, which is fluidly coupled to at least one water source, where water flow out of the outlet 105 is controllable via at least one controller 110. As shown in FIG. 1, the shower system 100 may also include one or more docking portions 115, which are structured to facilitate storage and/or mounting of one or more shower system components and/or accessories.

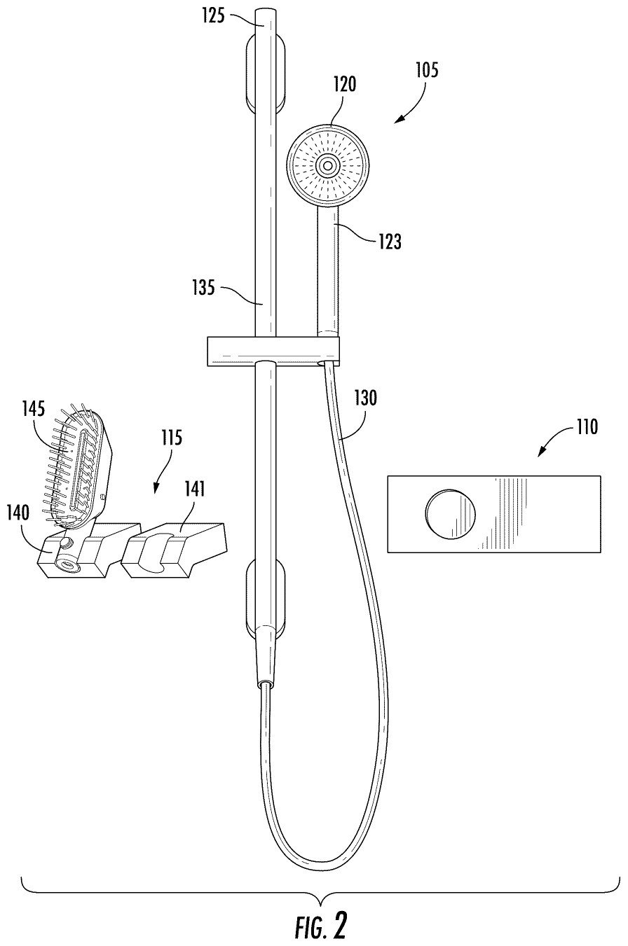

FIG. 2 is a front view of the shower system 100, according to an exemplary embodiment. As illustrated, the outlet 105 includes a spray head element, shown as spray head 120, which is fluidly coupled to a water source 125 (e.g., hot and cold water supply) via hose 130. The spray head 120 is removably coupled to a handle component, shown as a handle 123 (which may also be referred to as a water delivery component and/or a handshower base), which facilitates manipulation of the spray head 120 and fluidly couples the spray head to a water supply. As shown, the shower system 100 may also include one or more brackets 135 (e.g., one or more brackets and/or supports defining a shower rail), which are structured to be affixed within the bathing environment 10. The one or more brackets 135 are structured to facilitate adjustable mounting of the spray head 120, handle 123, and/or hose 130 within the bathing environment 10. As shown, the docking portion 115 may be disposed to a side of the one or more brackets 135. The docking portion 115 is structured to facilitate storage and/or mounting of one or more components of the shower system 100.

As illustrated in FIG. 2, the shower system 100 may include one or more docks, where each dock is structured to receive one or more components of the shower system 100. The docking portion 115 may include a first dock 140 and a second dock 141, which may be individually or jointly mounted within the bathing environment 10. Although FIG. 2 shows the shower system 100 including two docks, in various embodiments, the shower system 100 may include any number of docks (e.g., 1, 3, 5, 8, 13, etc.). Although FIG. 2 shows both the docks 140 and 141 being mounted in an adjacent arrangement and disposed on a same side of the shower system 100 (e.g., disposed on a same side of the bracket 135), in various embodiments, the docks 140, 141 may be disposed on different sides of the shower system 100. In various embodiments, the docks 140, 141 may be disposed on a same side of the shower system 100 as the controller 110. In other embodiments, the controller 110 may be disposed on an opposite side of the shower system 100 as the docks 140, 141 (e.g., on an opposite side of the bracket 135). In some embodiments, the controller 110 may include or be structured as a shelf to facilitate additional storage within the bathing environment 10.

The shower system 100 also includes a spray head 145. The spray head 145 may be mounted on one of the docks 140 or 141 independent from the handle 123. Although FIG. 2 shows the spray head 145 being mounted on the first dock 140, in various embodiments, the spray head 145 may be mountable on the second dock 141. In some embodiments, such as shown in FIG. 3, a shower system may also include multiple spray heads, shown as a first spray head 245, a second spray head 247, and a third spray head 220, which may be mountable to the docking system 215 (e.g., to one of the first dock 240 or the second dock 241) on one or both sides of the docking portion 225. The shower system is structured such that each of the first spray head 245, the second spray head 247, and the third spray head 220 may be interchangeably coupled to a handle 223 (e.g., a shared handle). Such an interchangeable arrangement allows the shower system to be customized by a user to enhance a bathing experience.

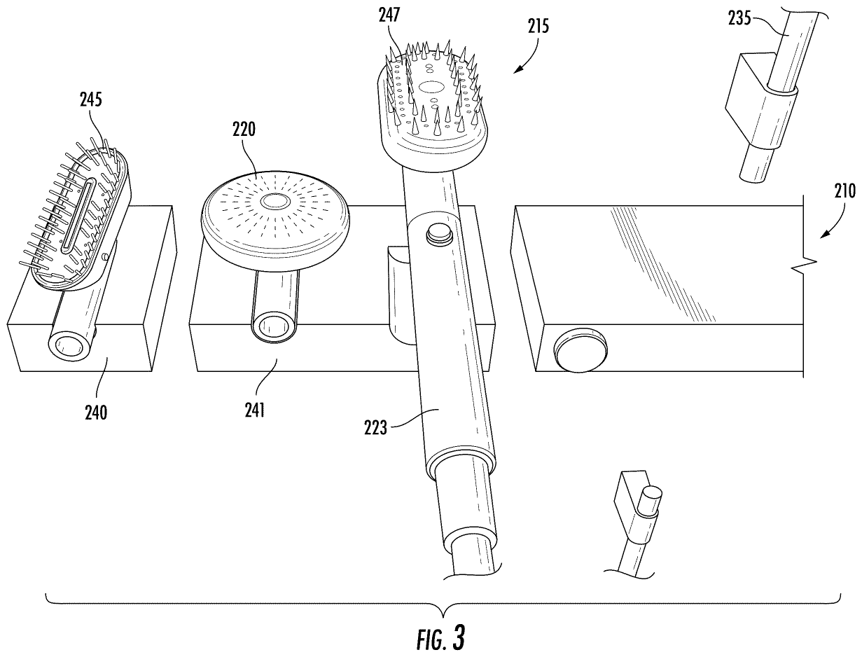

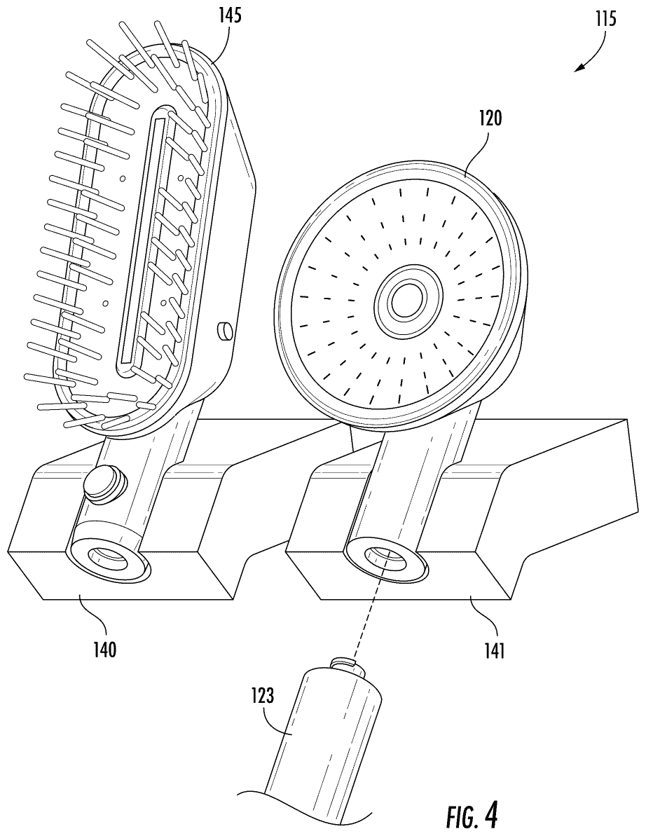

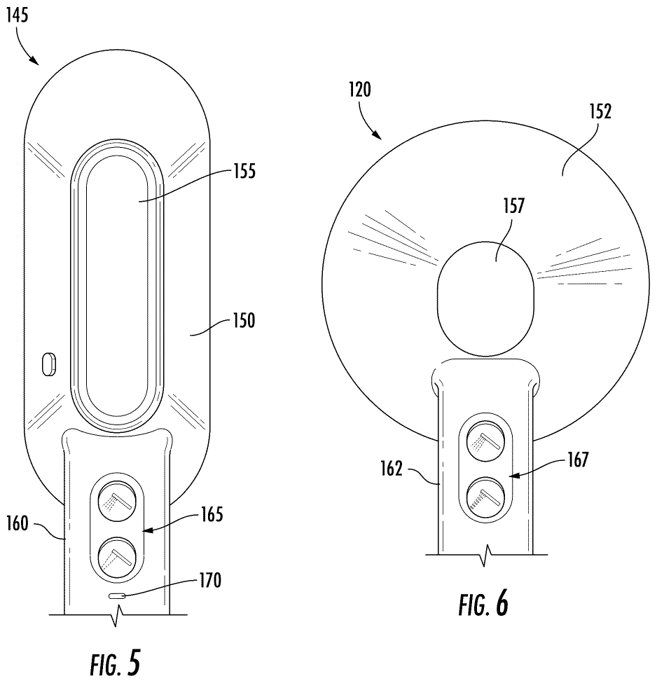

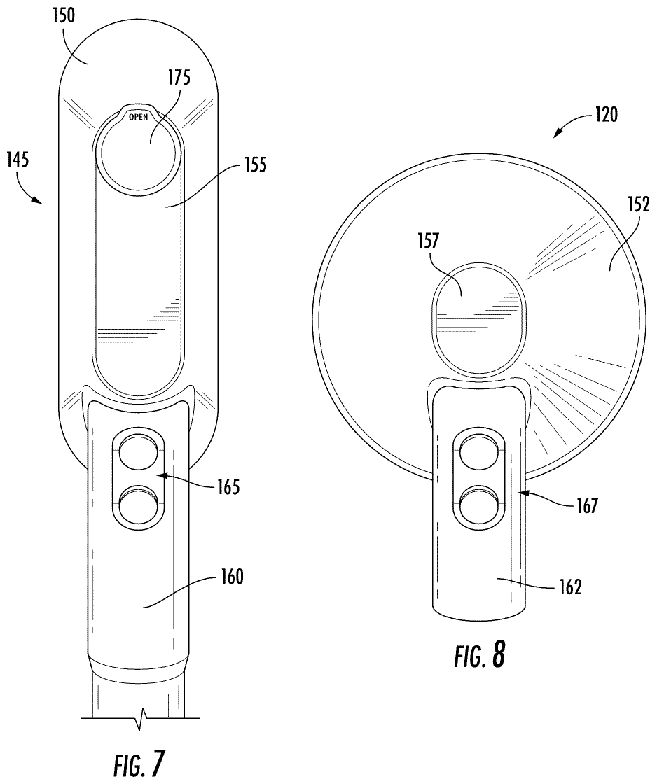

In various embodiments, each of the first spray head 245, the second spray head 247, and the third spray head 220 may be structured to have one or more different structural features and/or structured to provide one or more different spray profiles. For example, FIG. 4 shows a spray head 120 and the spray head 145 of FIG. 2 mounted respectively on the second dock 141 and the first dock 140 within the shower system 100. As shown, the spray heads 120 and 145 may be mounted on the docks 141 and 140 at an orientation such that the handle 123 may be readily connectable thereto. The spray head 145 and the spray head 120 each include a body 150 and 152, respectively. As shown in FIG. 6, the body 152 of the spray head 120 may be generally frustoconical in shape. As shown in FIG. 5, the body 150 of the spray head 145 may form an elongated frustoconical shape. Each of the bodies 150 and 152 may include a rear panel 155 and 157, respectively. The rear panels 155, 157 may be integrally formed or removably coupled to the respective bodies 150, 152 to facilitate ease of access to internal components (e.g., for the purposes of maintenance, replacement of one or more components, upgrading components, etc.). For example, as shown in FIG. 7, the spray head 145 may include a port or opening 175 disposed within the rear panel 155, where the opening 175 may enable replacement of one or more components (e.g., filtration capsules) within the spray head 145. It should be noted that although the figures show the spray head 145 including the opening 175, in various embodiments, the spray heads 120 and/or 147 may additionally or alternatively include an opening 175 disposed within respective rear panels.

Each of the spray heads 145 and 120 respectively include stems 160 and 162. The stem 160 extends from the body 150 and the stem 162 extends from the body 152. Each stem 160, 162 may be generally tubular in shape and configured to couple to at least a portion of the handle 123. In various embodiments, each of the stems 160, 162 may respectively include one or more controls 165, 167. The controls 165, 167 may include one or more buttons, knobs, levers, and/or switches configured to adjust a spray profile of the respective spray heads 145, 120 (i.e., adjust a characteristic of water flow from the spray heads 145, 120, such as a spray pattern produced by the spray heads 145, 120). In some embodiments, the controls 165, 167 may include individual buttons disposed within the respective stems 160, 162, such as shown in FIGS. 5 and 6. In other embodiments, the controls 165, 167 may be included within a panel or inlay disposed within the respective stems 160, 162, such as shown in FIGS. 7 and 8.

Referring to FIG. 5, in some embodiments, at least one of the stems 160, 162 may include an indicator 170. In various embodiments, the indicator 170 may include a light (e.g., LED). In some embodiments, the indicator 170 may be configured to indicate a characteristic of water flow through the stem and/or the spray head. As used herein, the “characteristic of water flow” may refer to at least one of a flow amount or a temperature of water flowing through the spray head 145 (or spray head 120). For example, if the water flowing through the spray head 145 (or spray head 120) is below a threshold temperature, the indicator 170 may display a green light and if the water flowing through the spray head 145 (or spray head 120) is above the threshold temperature, the indicator 170 may display a red light. In other embodiments, the indicator 170 may display a first color or symbol when the spray head 145 is configured to output water according to a first spray profile and display a second color or symbol when the spray head 145 is configured to output water according to a second spray profile. Although the figures show the spray head 145 having the indicator 170, in various embodiments, the spray head 120 and/or 147 may additionally or alternatively include the indicator 170.

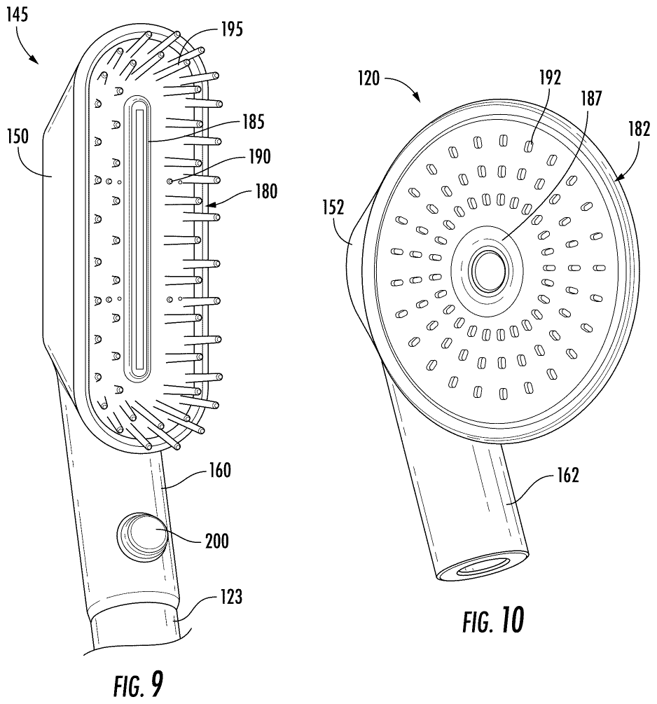

As indicated above, each of the spray heads 145 and 120 (and spray head 147) may be configured to provide multiple spray profiles and/or have one or more physical characteristics that enable use of the spray heads 145 and 120 for different use applications. As shown in FIGS. 9 and 10, the spray head 145 and the spray head 120 each define at least a portion of a spray face when coupled to the handle (e.g., a spray face defining a reference plane through which water is delivered from the handshower, or exists the shower system). As shown in FIGS. 9 and 10, the spray head 145 and the spray head 120 each include spray faces 180 and 182, respectively, which facilitate water flow out of the spray heads 145 and 120 (i.e., when the spray head 145 or spray head 120 is coupled to the hose 130). In some embodiments, the spray faces 180 and 182 are substantially planar spray faces. Each of the spray faces 180 and 182 may include one or more outlets or sets of outlets, which may provide a particular spray profile for water flowing out of the spray faces 180, 182. As shown in FIG. 9, the spray head 145 includes a first outlet 185, which is structured as an elongated aperture disposed within a substantially central portion of the spray face 180. In various embodiments, the first outlet 185 is configured to provide a concentrated flow of water (e.g., “waterfall”). The spray head 145 also includes a plurality of second outlets 190, which are structured as substantially circular apertures distributed about the spray face 180 within a region disposed between the first outlet 185 and an outer edge of the body 150. In various embodiments, the second outlets 185 are configured to provide a distributed flow of water (e.g., “global silk”). Similarly, as shown in FIG. 10, the spray face 182 of the spray head 120 may include a first outlet 187, which may be disposed within a central portion of the spray face 182. The first outlet 187 may include a singular opening or aperture configured to provide a single stream of water therethrough. In various embodiments, the first outlet 187 may be utilized to provide stream of water for deep cleaning. For example, in some embodiments, the spray head 120 may include a high-frequency vibration atomization unit (“nanobubble unit”), where the nanobubble unit is configured to reduce water droplet size to approximately a tenth the size of skin pores (e.g., less than one micron). Accordingly, when the spray head 120 is configured to provide water through the first outlet 187, the water flowing therefrom may be treated by the nanobubble unit to provide a deep cleaning for a user. In addition, as shown in FIG. 10, the spray head 120 may also include a plurality of second outlets 192, which are structured as substantially circular apertures distributed about the spray face 182 within a region disposed between the first outlet 187 and an outer edge of the body 152. In various embodiments, the second outlets 190 are configured to provide a distributed flow of water (e.g., “shower”).

In various embodiments, the spray head 145 may be configured to alternatively provide flow of water through the first outlet 185 and the second outlets 190 in a respective first mode and second mode. In some embodiments, the spray head 145 may be configured to switch between the first mode and the second mode via the controls 165, which are disposed on the stem 160. Similarly, the spray head 120 may be configured to alternatively provide flow of water through the first outlet 187 and the second outlets 192 in a respective first mode and second mode. In some embodiments, the spray head 120 may be configured to switch between the first mode and the second mode via the controls 167, which are disposed on the stem 162. In various embodiments, the spray head 145 may also include one or more controls 200 disposed on the stem 160, which may be configured to control water flow from the handle 123 into the spray head 145. As shown in FIG. 9, the controls 200 may include one or more buttons, knobs, levers, dials, or other features configured to adjust an amount of water flow from the handle 123 (i.e., from the hose 130) to the spray head 145. For example, in some embodiments, the controls 200 may be configured to pause a flow of water to the spray head 145. In other embodiments, the controls 200 may be configured to reduce the flow of water to a half flow (i.e., reduce a default flow of water by approximately 50%).

As shown in FIG. 9, the spray head 145 may also include a plurality of protrusions (“bristles”) 195 extending outwardly from the spray face 180. The bristles 195 may be distributed within a region of the spray face 180 disposed between the first outlet 185 and an outer rim of the body 150. The bristles 195 may be formed of a substantially elastic material such the bristles 195 may reversibly deform in response to an applied load. In some embodiments, the bristles 195 are configured to contact the skin of a user as water is flowing out of the spray head 145 (i.e., via the outlets 185 and/or 190) to provide a massaging or exfoliating effect. In other embodiments, the bristles 195 may be configured for use as a brush, to enable brushing of a user's hair or fur (e.g., if the user uses the spray head 145 to bathe an animal or pet).

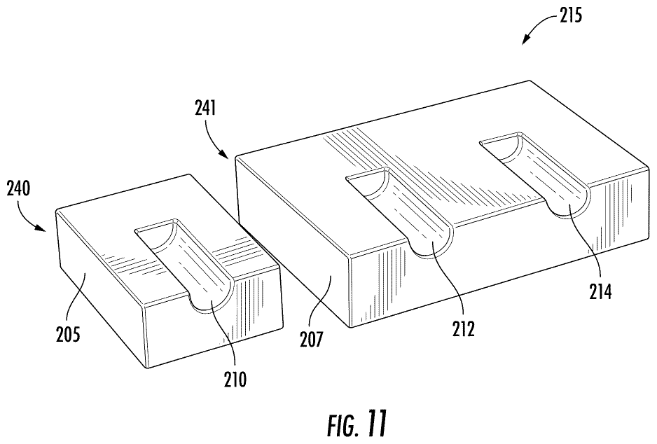

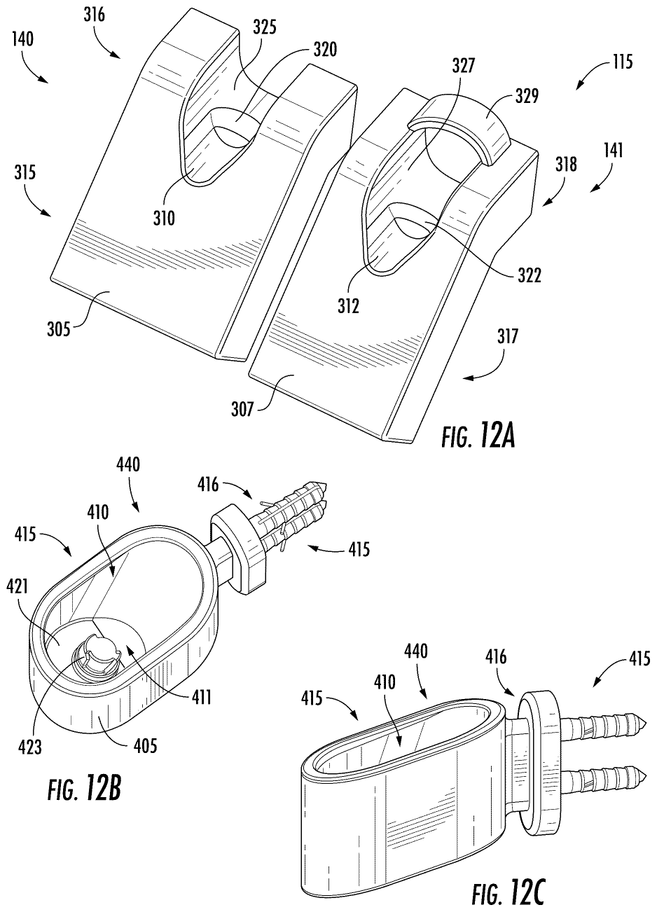

As described above with respect to FIG. 2 (and FIG. 3), the shower system 100 includes one or more docking portions 115, which may be mounted within the bathing environment 10 and which facilitate mounting of the spray heads 120, 145, and 147 until use (e.g., during periods of non-use of the spray heads). FIGS. 11 and 12A illustrate perspective views of the first docks 140, 240 and the second docks 141, 241, respectively. In various embodiments, such as shown in FIG. 11, the first dock 240 and the second dock 241 may each have a respective body, shown as a first body 205, and a second body 207. In various embodiments, such as shown in FIG. 11, each of the bodies 205, 207 may be substantially rectangular in shape. In various embodiments, the first dock 240 may include a recess 210. In some embodiments, the recess 210 may have a shape that is complimentary to a shape of the stems 160 and/or 162 (i.e., of the spray heads 145 and/or 120, respectively as shown in FIGS. 9 and 10). In various embodiments, the recess 210 may have a generally cylindrical channel that includes a ridge, which is structured to facilitate retention of the spray heads 120, 145, and/or 147 within the first dock 240. Similarly, the second dock 241 may include two recesses 212 and 214. In some embodiments, each of the recesses 212, 214 may have a shape that is complimentary to a shape of the stems 160 and/or 162 (i.e., of the spray heads 145 and/or 120, respectively). The recesses 212 and 214 may have a generally cylindrical channel that includes a ridge, which is structured to facilitate retention of the spray heads 120, 145, and/or 147 (see also FIGS. 3, 9, and 10) within the second dock 241. Although FIG. 11 shows the first dock 240 including a singular recess 210 and the second dock including two recesses 212, 214, in various embodiments, the first dock 240 and the second dock 241 may include any number of recesses. For example, in some embodiments, the first dock 240 may include more than one recesses 210 (e.g., 2, 4, etc.). In some embodiments, as shown in FIG. 12A, the second dock 141 may include only one recess 312. In other embodiments, the second dock 141 may include more than two recesses.

In some embodiments, as shown in FIG. 12A, the first dock 140 and/or the second dock 141 may be contoured to have an inclined shape. As shown, in some embodiments, the body 305 of the first dock 140 may include a first portion 315 and an integrally formed second portion 316, where the second portion 316 is structured to couple to a surface (e.g., wall) within the bathing environment and the first portion 315 may be disposed at an angle relative to the second portion 316. In some embodiments, the first dock 140 may be structured such that the angle between the first portion 315 and the second portion 316 facilitates ease of access (e.g., ease of mounting, ease of removal, etc.) to the spray heads 120, 145, and/or 147 (see FIG. 2) when mounted to the first dock 140. In some embodiments, the first dock 140 may also include one or more features to facilitate retention of the spray heads 120, 145, and/or 147 when mounted to the first dock 140. For example, as shown in FIG. 12A, the first dock 140 may include a second recess 325 that is substantially coaxial with the recess 310. The second recess 325 may be offset from the recess 310 by a ridge 320. In various embodiments, the recess 310, second recess 325, and the ridge 320 are structured to conform to a contour of the spray heads, 120, 145, and/or 147 when mounted to the first dock 140. Similarly, the body 307 of the second dock 141 may include a first portion 317 and an integrally formed second portion 318, where the second portion 318 is structured to couple to a surface (e.g., wall) within the bathing environment and the first portion 317 may be disposed at an angle relative to the second portion 318. In some embodiments, the second dock 141 may be structured such that the angle between the first portion 317 and the second portion 318 facilitates ease of access (e.g., ease of mounting, ease of removal, etc.) to the spray heads 120, 145, and/or 147 when mounted to the second dock 141. In some embodiments, the second dock 141 may also include one or more features to facilitate retention of the spray heads 120, 145, and/or 147 when mounted to the second dock 141. For example, as shown in FIG. 12A, the second dock 141 may include a second recess 327 that is substantially coaxial with the recess 312. The second recess 327 may be offset from the recess 312 by a ridge 322. In various embodiments, the recess 312, second recess 327, and the ridge 322 are structured to conform to a contour of the spray heads, 120, 145, and/or 147 (see FIG. 2) when mounted to the second dock 141. In some embodiments, the second dock 141 may also include a rim 329, which extends across the second recess 327 within the second portion 318. The rim 329 may be a stationary structure to which the spray heads 120, 145, and/or 147 or a portion thereof) may be mounted, hooked, etc. In other embodiments, the rim 329 may be removably coupled from the second dock 141 such that the rim 329 is configured to enclose a portion of the spray heads 120, 145, and/or 147 to facilitate retention thereof.

In yet other embodiments, such as shown in FIGS. 12B and 12C, the docking portion 415 may include one or more docks structured to mount within the bathing environment. As shown in FIG. 12C, the dock 440 may be structured such the first portion 415 extends from the second portion 416 at an angle. For example, as illustrated in FIG. 12C, the first portion 415 angles downward from the second portion 416 to facilitate ease of access. As shown in FIG. 12B (and also referring to FIGS. 9 and 10), the dock 440 may be structured such that the first portion 415 of the body 405 is shaped such that it may substantially surround the stem 160 (and/or the stem 162). In various embodiments, the first portion 415 may have an ellipsoidal shape. In other embodiments, the first portion 415 may have a circular shape. In yet other embodiments, the first portion 415 may have a rectangular shape. As shown, in some embodiments, the first portion 415 is shaped such than an inner surface of the first portion 415 defines the recess 410. In some embodiments, the first portion 415 may also include one or more apertures 411 disposed within a bottom surface 421, where the one or more apertures 411 may be structured to facilitate drainage. In various embodiments, the first portion 415 may also include one or more mounts 423 disposed on the bottom surface 421, where the one or more mounts 423 may be structured to receive and/or couple to the stem 160 (and/or the stem 162). For example, the one or more mounts 423 may include one or more retention features structured to couple to the stem 160 (and/or the stem 162) to secure the spray head 145 (and/or the spray heads 120 or 147) to the dock 440.

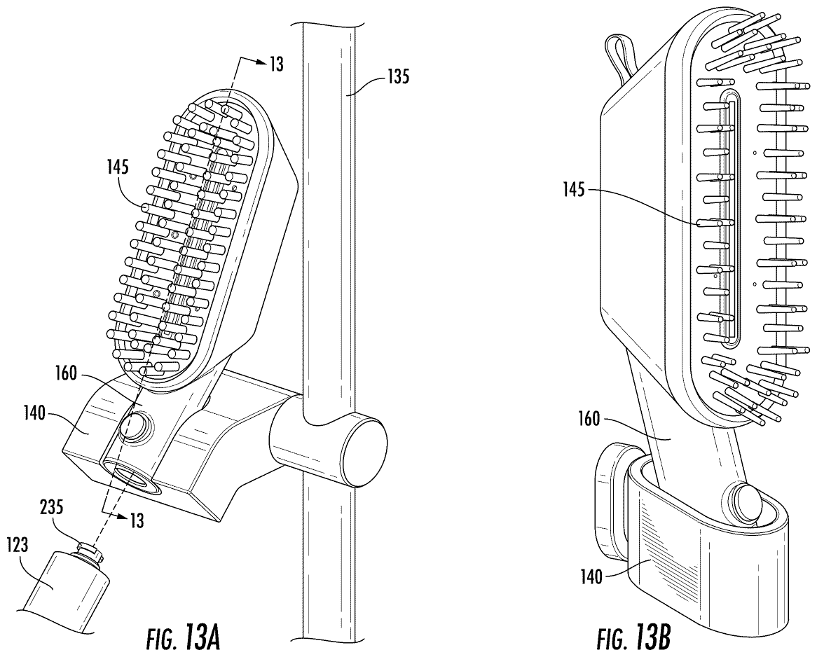

Referring to FIG. 13A, in some embodiments, the first dock 140 and/or the second dock 141 may be structured to couple to the bracket 135. Coupling the docks 140 and/or 141 to the bracket 135 may enable increased adjustability of a position (e.g., height, amount of rotation, etc.) of the docks 140 and/or 141 within the bathing environment 10.

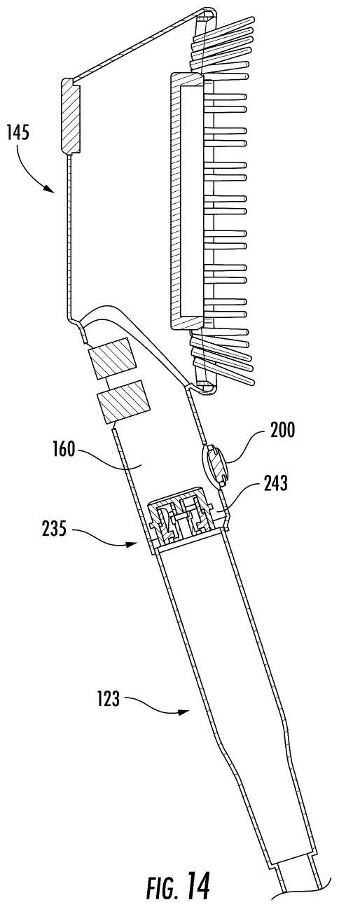

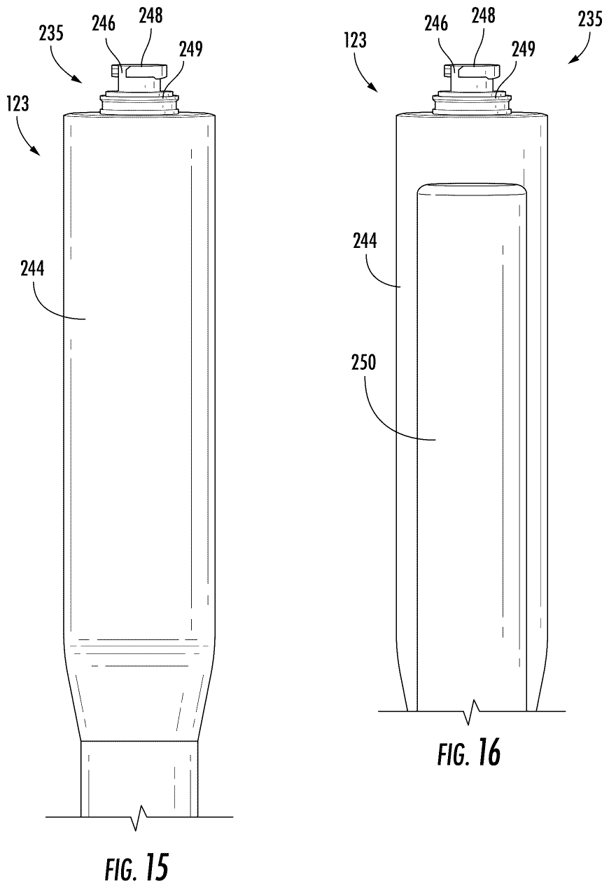

As described above, each of the spray heads 120, 145, and 147 is configured to interchangeably couple to the handle 123 such that a user may readily customize a showering experience by selecting a suitable spray head (e.g., one of the spray heads 120, 145, 147) for a particular use application. As shown in FIG. 13A, which illustrates the spray head 145 mounted on the first dock 140, the handle 123 may include a connecting portion 235 (which may also be referred to as a first connecting portion), which is configured to be received within the stem 160. As shown in FIG. 14, when the handle 123 is coupled to the spray head 145, the connecting portion 235 is retained within a receiving portion 243 (which may also be referred to as a second connecting portion) of the stem 160. In such an arrangement, the connecting portion 235 nests within the receiving portion 243. In some embodiments, and as will be further described, the receiving portion 243 or the connecting portion 235 is configured to removably couple the spray head to the handle 123 at the other of the connecting portion 235 or the receiving portion 243 via a twist-lock connection. Such an arrangement can facilitate forming a watertight seal and can provide enhanced durability in the context of a handshower attachment. In other embodiments, such as shown in FIG. 13B, the stem 160 (or the stem 162) may be received within the dock 140. In various embodiments, the mount 424 (shown in FIG. 12B) may be structured to resemble one or more features of the connecting portion 235 of the handle 123. It should be noted that although FIGS. 13A-13B and FIG. 14 show the spray head 145, in various embodiments, the handle 123 is also configured to couple to a respective stem and receiving portion of the spray heads 120 and/or 147 (shown in FIG. 3). It should be understood that the geometry of the connecting portion 235 and the receiving portion 243 may be reversed in some embodiments.

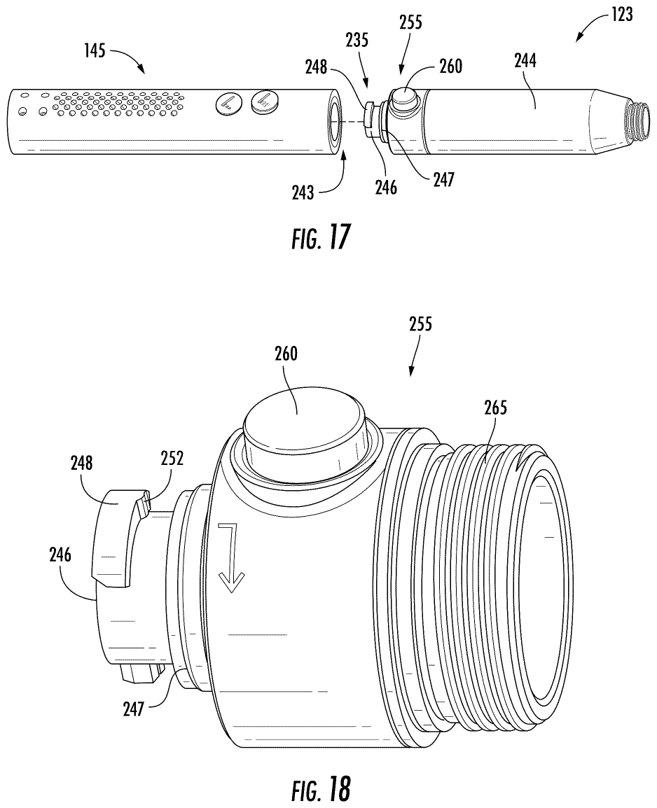

As shown in FIGS. 15 and 16, the handle 123 may include an elongated portion 244, which is structured to facilitate gripping and handling of the handle 123. The elongated portion 244 may also be configured to fluidly couple the handle 123 to a water supply. In some embodiments, the elongated portion 244 may be substantially cylindrical in shape. In other embodiments, the elongated portion 244 may be rectangular, hexagonal, or any other suitable shape for enabling grip thereof. In some embodiments, the elongated portion 244 may include one or more grip regions. In other embodiments, the elongated portion 244 may be coated with one or more high-friction materials to facilitate gripping/handling. In yet other embodiments, the elongated portion 244 may be ergonomically shaped to have a shape or contour that is complementary to a user's hand. In some embodiments, such as shown in FIG. 16, the elongated portion 244 may include one or more filters 250, which are configured to filter water flowing through the handle 123. In some embodiments, the one or more filters 250 may include a Vitamin C filter.

The connecting portion 235 of the handle 123 is disposed at a central location along a flow path therethrough (e.g., at a central location on an outlet side of the handle 123). The connecting portion 235 may include a central post 246, which includes a lower ridge 249 and at least one upper ridge 248, where the lower and upper ridges 249, 248 are structured to engage with one or more corresponding features within the receiving portion 243. The central post 246 may extend (e.g., axially relative to a central axis of the elongated portion 244) from the elongated portion 244, from an axial end of the elongated portion 244. In various embodiments, the lower ridge 249 may extend about a circumference of the post 246 and may be disposed adjacent to one or more gaskets or seals (e.g., o-rings). In some embodiments, the upper ridge 248 may extend about only a portion of the circumference of the post 246. In various embodiments, the post 246 may include two upper ridges 248, which are disposed on opposite sides of the post 246. In some embodiments, the upper ridges 248 define a portion of a twist-lock mechanism that is configured to removably couple the connecting portion 235 to the receiving portion 243. In some embodiments, at least one of the upper ridges 248 includes a step 252 (e.g., a protrusion extending axially from an upper or lower surface of the upper ridge). The step 252 may be configured to engage a detent in the receiving portion 243 to detachably couple the connecting portion 235 to the receiving portion 243. In some embodiments, the handle 123 may be coupled to the spray head 120, 145, and/or 147 by first inserting the connecting portion 235 into the receiving portion 243 (e.g., of the spray head 120, 145, or 147) and subsequently rotating the handle 123 (i.e., relative to the spray head 120, 145, or 147) such that the one or more upper ridges 248 engage with one or more corresponding features disposed in the receiving portion 243 to prevent separation of the handle 123 from the spray head 120, 145, or 147. In some embodiments, the handle 123 may be structured such that the one or more upper ridges 248 are retractable, where a button or other control disposed on the elongated portion 244 may controllably retract the one or more upper ridges 248 to facilitate engagement and disengagement of the connecting portion 235 with the receiving portion 243.

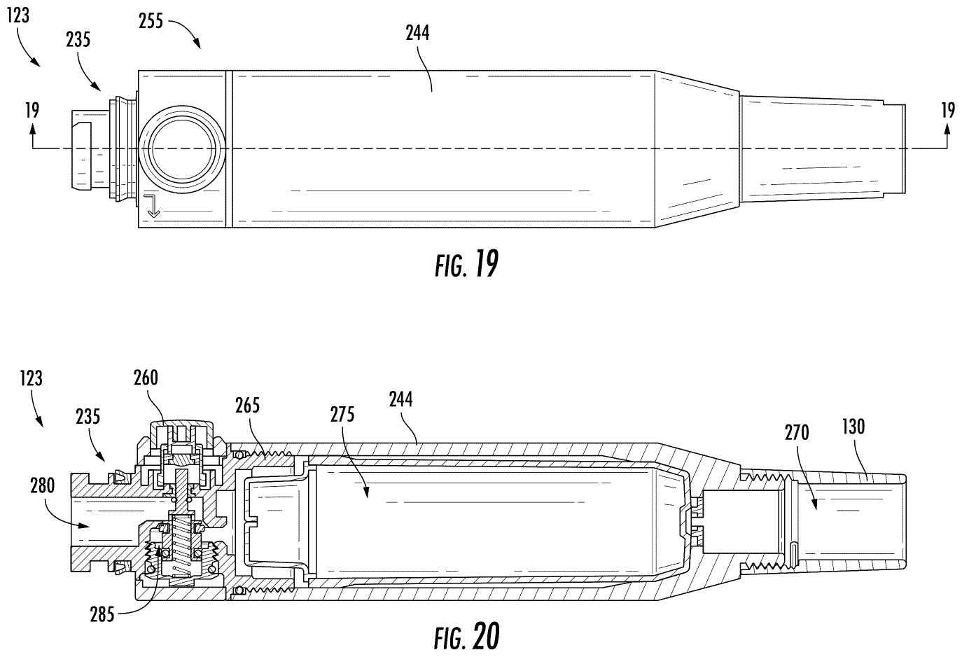

In various embodiments, the handle 123 may include a water flow control portion 255, as shown in FIGS. 17-19. The water flow control portion 255 may be configured to control an amount or characteristic of water flow through the handle 123. In some embodiments, the water flow control portion 255 may be disposed between the elongated portion 244 and the connecting portion 235. The water flow control portion 255 may include one or more controls 260, which may be configured to adjust the amount or characteristic of water flow through the handle 123. In various embodiments, the one or more controls 260 may include buttons, knobs, dials, levers, or any other suitable control mechanism known in the art. As shown in FIG. 18, in various embodiments, the water flow control portion 255 be removably coupled to the elongated portion 244 of the handle 123. In some embodiments, the water flow control portion 255 may include a plurality of threads 265, which may engage with an end of the elongated portion 244. In other embodiments, the water flow control portion 255 may be integrally formed with the connecting portion 235 and/or the elongated portion 244.

As shown in FIGS. 20-22, the water flow control portion 255 includes a flow adjustment mechanism 285, which is controllable by the one or more controls 260. The flow adjustment mechanism 285 is configured to adjust a flow of water from interior passageways 270 and 275 of the respective hose 130 and elongated portion 244 to a passageway 280, which is disposed within the connecting portion 235. The flow adjustment mechanism 285 includes a piston 300, which is coupled to or engages with a seat 295. The seat 295 engages with a connector 290, which is coupled to the control 260 (depicted as a button) such that actuation (e.g., depression) of the control 260 causes displacement of the piston 300.

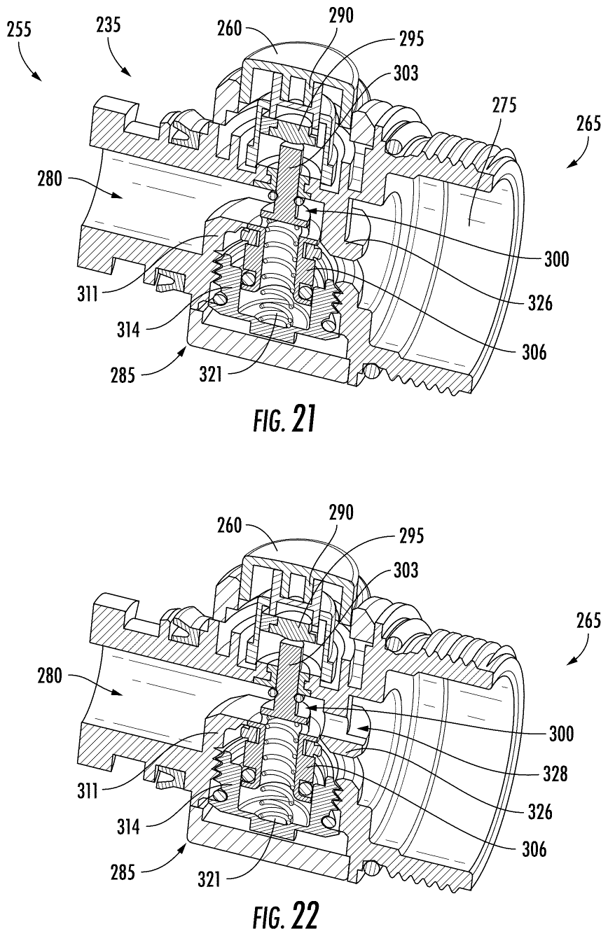

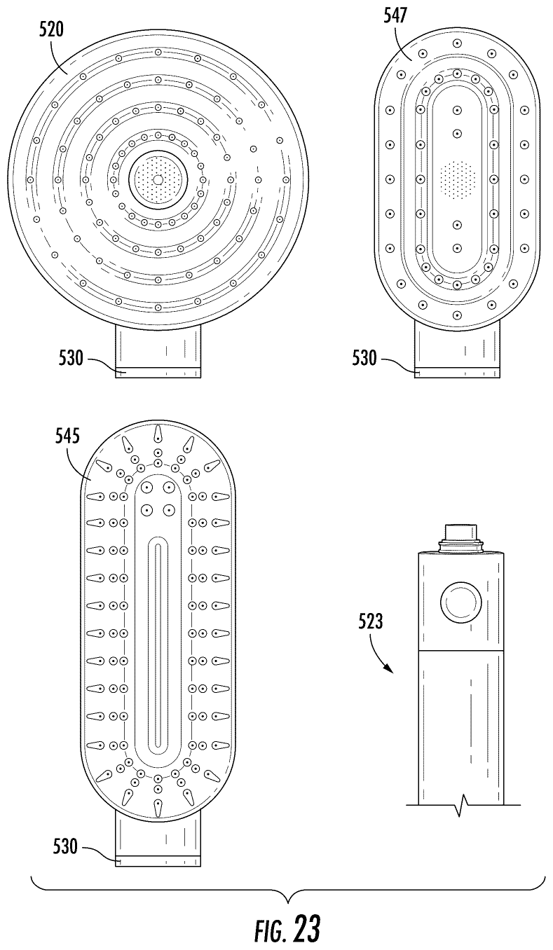

As shown in FIGS. 21-22, the piston 300 includes a first portion 303 and a second portion 306, where the first portion 303 engages with the seat 295 and the second portion 306 engages with a base 314. As shown, the second portion 306 has a larger diameter than the first portion 303. The second portion 306 is structured to receive a spring member 321 within an interior region thereof. The spring member 321 is coupled to an anchor portion, which is disposed within the base 314. Accordingly, to spring member 321 may bias the piston 300 toward the seat 295. As described above, actuation (e.g., depression) of the control 260 causes displacement of the piston 300, where displacement of the piston 300 adjusts water flow through the mechanism 285 (i.e., from the passageway 275 to the passageway 280). As shown in FIG. 21, the water flow control portion 255 includes a ridge 326, which extends from a sidewall of the water flow control portion 255 into a water flow pathway defined through the mechanism 285. The ridge 326 is disposed adjacent the piston 300 such that when the piston 300 is biased toward the seat 295, the second portion 306 abuts the ridge 326 to prevent water flow through the mechanism 285. Accordingly, when the control 260 is depressed to displace the piston 300 toward the housing 311, the first portion 303 is disposed adjacent the ridge 326 to allow water flow through the mechanism 285. In this manner, the control 260 may be used to selectively stop or pause water flow through the handle 123 (i.e., and thereby to the spray head 120, 145, or 147).

In other embodiments, such as shown in FIG. 22, the ridge 326 may include and/or define an aperture 328. Accordingly, when the piston 300 is biased toward the seat 295, the second portion 306 abuts the ridge 326 and water flows through the aperture 328. When the control 260 is depressed to displace the piston 300 toward the housing 311, the first portion 303 is disposed adjacent the ridge 326 to allow water flow through the mechanism 285. Water flow through the mechanism 285 may thus have a first flow rate when the piston 300 is biased toward the seat 295 and a second flow rate when the piston 300 is displaced toward the housing 311. In various embodiments, the first flow rate may be approximately half the second flow rate. Accordingly, when the ridge 326 includes an aperture 328, the control 260 may be used to selectively reduce a water flow through the handle 123 (i.e., and thereby to the spray head 120, 145, or 147).

In various embodiments, portions of the shower system may be structured to reduce a risk of injury to a user. As shown in FIG. 23, the spray heads 520, 545, and/or 547 may include at least one indicator 530 disposed on the stem, where the indicator 530 may be configured to indicate to a user at least one of a temperature or flow rate of water flowing from the handle 523 to the spray head 520, 545, or 547. In various embodiments, the indicator 530 may be disposed circumferentially about the stem of the spray heads 520, 545, and/or 547. In some embodiments, the indicator 530 may include a light (e.g., LED) or other visual indicator that may change in color and/or intensity based on a temperature or flow rate of water. For example, in some embodiments, the indicator 530 may display a red color if the temperature of water is above a first threshold amount to indicate risk of scalding to a user. In other embodiments, the indicator 530 may display a blue color if the temperature of water is below a second threshold amount to indicate the water is not sufficiently warm for use. In other embodiments, the indicator 530 may display a green color if the water temperature is between the first and second threshold to indicate to a user that the water is in a suitable temperature range for use. In other embodiments, the indicator 530 may blink or have an intensity corresponding to a water flow rate. For example, the indicator 530 may blink at a first frequency corresponding to a first water flow rate and may blink at a second frequency corresponding to a second flow rate.

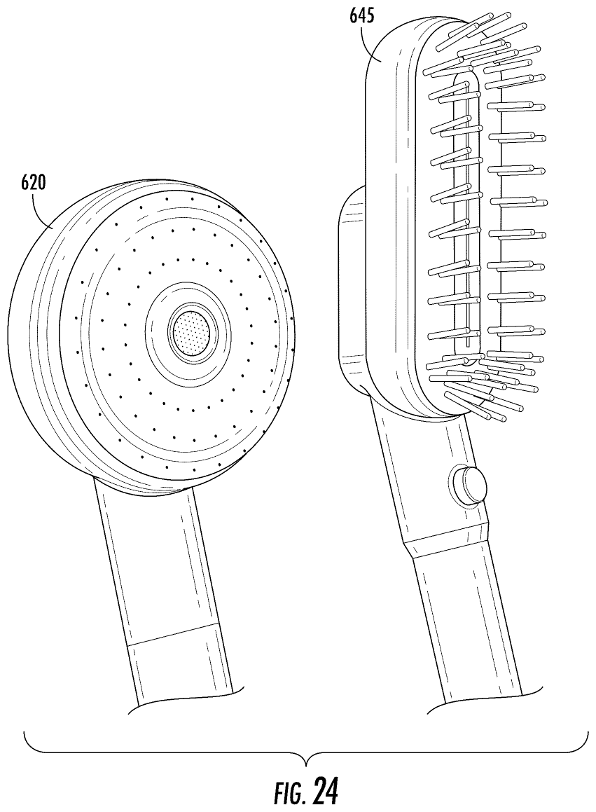

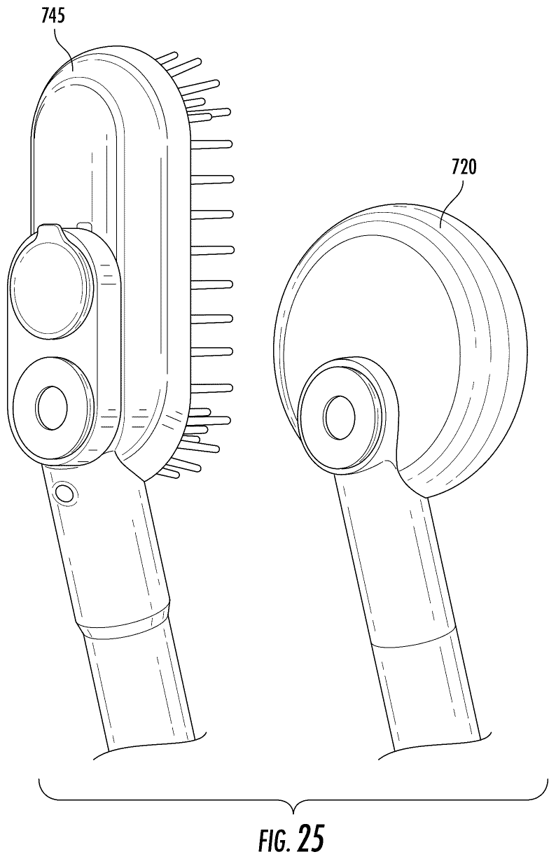

In various embodiments, one or more components of the shower system may be aesthetically customizable to enhance user experience. For example, although FIGS. 1-23 illustrate components of the shower system to include angled features, in various embodiments, components of the shower system may include rounded edges-such as shown for the spray heads 620, 645 in FIG. 24, and the spray heads 720, 745 in FIG. 25. In some embodiments, components of the shower system (e.g., spray heads 120, 145) may include a matte, textured, or chrome finish.

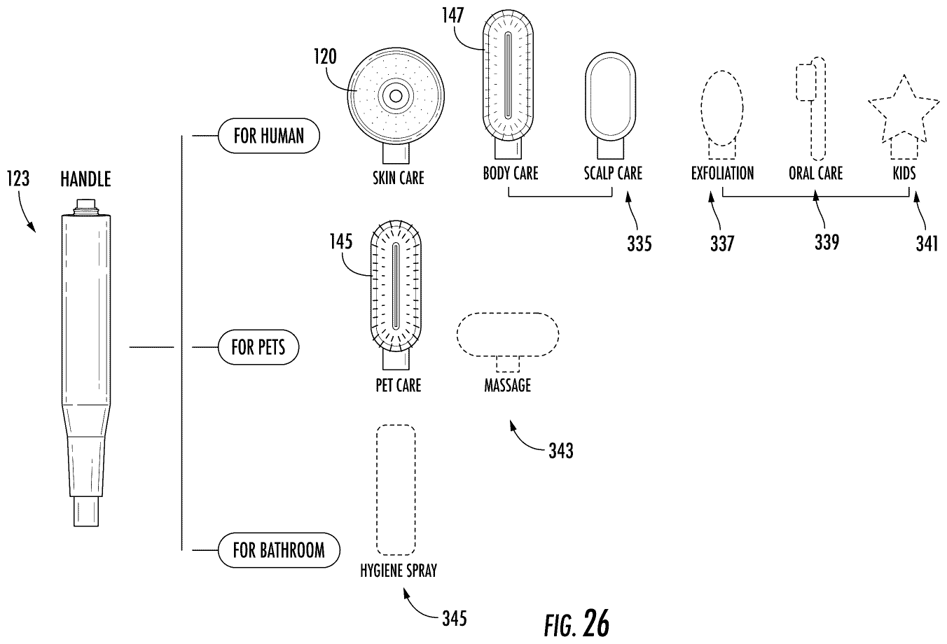

Although reference has been made to spray heads 120, 145, and 147, it should be understood that the shower system 100 may include more or fewer spray heads, where each is configured for a particular use application (e.g., human uses, pet uses, bathroom uses, etc.). For example, as shown in FIG. 26, the spray head 820 may be configured for skin care, the spray head 845 may be configured for pet care, and the spray head 847 may be configured for body care. Similarly, the shower system may be additionally or alternatively structured to include a spray head 835 configured for scalp care, a spray head 837 configured for exfoliation, a spray head 839 configured for oral care, and/or a spray head 841 configured for use on children. In yet other embodiments, the shower system may include additional spray heads 843 configured for pet massage care and/or spray heads 845 configured for hygiene spray (i.e., in a bathroom setting).

Referring again to FIGS. 1-3 and FIGS. 15-17, during use of the shower system, the spray heads 120, 145, and/or 147 may be mounted within the bathing environment 10 (i.e., to the first dock 140 and/or second dock 141). The handle 123 may be then coupled to a first spray head (i.e., of the spray heads 120, 145, or 147) by inserting the connecting portion 235 of the handle 123 into the receiving portion 243 of the first spray head (i.e., of the spray head 120, 145, or 147) and rotating the handle 123 relative to the first spray head. Water flow to the handle 123 may be controlled using the at least one controller 110 water flow from the handle 123 to the first spray head may be paused or adjusted using the control 260. When use of the first spray head is concluded, the handle 123 may be separated therefrom and connected to a second spray head (i.e., of the spray heads 120, 145, or 147) for further use. For example, a user may first connect the handle 123 to the spray head 147 for general body cleansing and care and subsequently connect the 123 to the spray head 120 for focused skin care, where the spray head 147 may be mounted to the first dock 140 or second dock 141 after disconnection from the handle 123.

Notwithstanding the embodiments described above in FIGS. 1-26, various modifications and inclusions to those embodiments are contemplated and considered within the scope of the present disclosure.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data, which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1-2. (canceled)

3. A shower system comprising:
a handle comprising a connecting portion; and
a plurality of interchangeable spray heads, each of the interchangeable spray heads comprising a receiving portion configured to be removably coupled to the connecting portion via a twist-lock connection to couple the respective spray head to the handle, the handle including a control configured to adjust a flow of water through each of the interchangeable spray heads.

4. The shower system of claim 3, wherein the handle comprises:
an elongated portion configured to fluidly couple the handle to a water supply; and
a water flow control portion removably coupled to the elongated portion, the water flow control portion comprising the control.

5. The shower system of claim 3, wherein the connecting portion comprises:
a central post;
a lower ridge extending about a circumference of the central post and configured to support a seal member; and
an upper ridge extending about only a portion of the circumference of the central post.

6. The shower system of claim 5, wherein the upper ridge is one of two upper ridges that are disposed on opposite sides of the central post.

7. The shower system of claim 6, wherein the upper ridges define a portion of a twist-lock mechanism that is configured to removably couple the connecting portion to the receiving portion.

8. The shower system of claim 6, wherein the upper ridges are retractable.

9. The shower system of claim 3, comprising an indicator configured to indicate a characteristic of water flow through the respective spray head.

10. The shower system of claim 9, wherein the indicator includes a light that is configured to visually indicate the characteristic of water flow to a user.

11. The shower system of claim 3, wherein at least one of the interchangeable spray heads includes a second control configured to control a spray pattern produced by the at least one interchangeable spray head.

12. The shower system of claim 3, wherein the interchangeable spray heads each comprise:
a body defining a spray face; and
a stem extending from the spray face, the stem defining the receiving portion.

13. The shower system of claim 3, comprising a docking portion configured to support the interchangeable spray heads thereon independent from the handle.

14. A shower system comprising:
a handshower base configured to be fluidly coupled to a water supply, the handshower base comprising a first connecting portion; and
a plurality of interchangeable spray head elements, each of the interchangeable spray head elements comprising a second connecting portion configured to removably couple the respective spray head to the handshower base at the first connecting portion via a twist-lock connection, at least one of the first connecting portion and the second connecting portion configured to nest within the other of the first connecting portion and the second connecting portion when the respective spray head element is coupled to the handshower base, the interchangeable spray head elements each defining at least a portion of a spray face when coupled to the handshower base.

15. The shower system of claim 14, wherein at least one of the interchangeable spray head elements comprises a plurality of bristles extending from the portion of the spray face.

16. The shower system of claim 14, wherein the spray face defines a reference plane through which water is delivered from the shower system.

17. The shower system of claim 14, wherein the spray face is a substantially planar.

18. The shower system of claim 14, wherein one of the first connecting portion or the second connecting portion comprises:
a central post; and
an upper ridge extending about only a portion of a circumference of the central post.

19. The shower system of claim 18, wherein the upper ridge is one of two upper ridges that are disposed on opposite sides of the central post.

20. The shower system of claim 19, wherein the upper ridges define a portion of a twist-lock mechanism that is configured to removably couple the first connecting portion to the handshower base at the second connecting portion.

21. A handshower comprising:
a handle comprising a first connecting portion; and
an interchangeable spray head element comprising a second connecting portion, the second connecting portion configured to be removably coupled to the first connecting portion via a twist-lock connection to couple the interchangeable spray head element to the handle, the interchangeable spray head element defining at least a portion of a spray face of the handshower when the interchangeable spray head element is coupled to the handle.

22. The handshower of claim 21, wherein the first connecting portion or the second connecting portion comprises:
a central post; and
an upper ridge extending about only a portion of a circumference of the central post, the upper ridge including a step extending axially from an upper or lower surface of the upper ridge.
